(19) United States
(12) Patent Application Publication
(10) Pub. No.: US 2026/0299919 A1
(43) Pub. Date: Oct. 1, 2026

(54) IN-PLACE UPDATES

(71) Applicant: ELECTRONIC ARTS INC., Redwood City, CA (US)

(72) Inventor: HENDRIKUS LAMBERTUS JOHANNES VAN VEENENDAAL, Vancouver (CA)

(21) Appl. No.: 19/094,419

(22) Filed: Mar. 28, 2025

(51) Int. Cl. G06F 8/65; G06F 8/36

(52) U.S. Cl. CPC G06F 8/65; G06F 8/36

(57) ABSTRACT

Systems and methods are provided for implementing an in-place update of a locally-installed software product from a current build to a new build. For example, the disclosed technology can organize reusable data in a patch plan and determine a data movement operation in the patch plan that moves the first reusable data to an overlapping storage location of the second reusable data. In response to determining that the second reusable data is to be reused in the target software build, the disclosed technology can update the data movement operation in the patch plan to utilize one or more memory buffers to maintain the accuracy of the reusable data.

### CROSS-REFERENCE TO RELATED APPLICATIONS

This application is related to co-owned U.S. patent application Ser. No. 16/364,638, filed Mar. 26, 2019, now abandoned, and co-pending, co-owned U.S. patent application Ser. No. 18/620,043, filed on Mar. 28, 2024, the contents of which are incorporated herein by reference in their entirety.

### TECHNICAL FIELD

The present disclosure is generally related to content delivery networks (CDNs), and more particularly related to server-side systems and methods of software patching, where a determination can be made regarding what portions of existing files can be reused and/or reordered to form a patch plan.

### BACKGROUND

Software products may be distributed, in the form of one or more files, to multiple computing devices by a CDN. Each of the files may store one or more software resources, such as executable code files, data files, graphic assets (e.g., textures, still images, fonts, animated images, video streams), multimedia assets, sound streams, etc. Examples of software products include video games, virtual social spaces, content creation applications, and other interactive, social, and/or entertainment applications of the like. As modern software products are changed or updated over the course of their life cycles, CDNs are increasingly tasked with distributing software patch plans to computing devices. Over time, these changes or patches to the software products can be problematic for computing devices with limited memory storage capacity. Accordingly, there is a need for an efficient patching method that minimizes hardware resources for software product updates.

### SUMMARY

In accordance with one embodiment, a system may comprise a processor, and a computer readable memory storage medium storing instructions that when executed, cause the processor to organize first reusable data and second reusable data in a patch plan, the patch plan defining data movement and storage operations to update a current software build to a target software build. The processor may determine a data movement operation that moves the first reusable data to an overlapping storage location of the second reusable data. The processor may, in response to determining that the second reusable data is to be reused in the target software build, update the data movement operation to: store the second reusable data in a memory buffer prior to initiating the data movement operation to the overlapping storage location, store the first reusable data from the source location to the target location, and store the second reusable data from the memory buffer to the target location. The processor may initiate the data movement operation of the first reusable data and second reusable data in accordance with the patch plan.

In some examples, an initial patch plan may describe copy or movement operations from a source location to a target location. The system may iteratively scan through the copy operations from the patch plan and reorder the operations such that the first copy operation is moving data that is closest to the beginning of the target location. An updated patch plan may be generated with this reordered copy operation. If the target location is clear, the system may simply move the copy operation to the updated patch plan. However, if the target location is occupied by second data that needs to be reused (and not overwritten), the system may copy the second data to a memory buffer to preserve the data. By utilizing a memory buffer, the conflicts that may be introduced by moving reusable data from a source location to a target location, in-place at the file, may be avoided. The updated patch plan can resolve any conflicts and be used to execute the data movement process in accordance with the new patch plan.

In accordance with one embodiment, a system may comprise a processor, and a computer readable memory memory-readable storage medium storing instructions that when executed, cause the processor to create, among a content delivery network, a patch plan for updating a plurality of software builds of a video game to each subsequent software build of the video game among the plurality. In some examples, each patch plan created the system is configured to identify reusable resources of a source software build for a target software build, concatenate adjacent blocks representative of the identified reusable resources for use in the target software build, identify additional resources for the target software build based on edges of the identified reusable resources, identify downloadable resources for the target software build, and create a patch plan in accordance with the identified reusable resources and the downloadable resources. The processor may receive a request to update a video game from the source software build to the target software build. The processor may identify, in response to the request, the patch plan corresponding to the video game update from the source software build to the target software build and send the corresponding patch plan.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a schematic representation of an example content delivery network (CDN) in which embodiments of the disclosed technology may be implemented.

FIG. 2 is an example computing component that may be used to create a patch plan in accordance with an embodiment of the disclosed technology.

FIG. 3 is an example computing component that may be used to identify reusable resources of a current build in accordance with an embodiment of the disclosed technology.

FIG. 4 illustrates an example scanning operation to identify reusable resources in accordance with instructions executed by the example computing component of FIG. 3.

FIG. 5 illustrates an in-place update operation with a source location and target location.

FIG. 6 is an example computing component that may be used to implement in-place updates using the patch plan in accordance with an embodiment of the disclosed technology.

FIG. 7 illustrates in-place updates for a software product, a patch plan with source locations and target locations, and a memory buffer, in accordance with an embodiment of the disclosed technology.

FIG. 8 is an illustrative process for implementing in-place updates for a software product, a patch plan with source locations and target locations file, and two memory buffers, in accordance with an embodiment of the disclosed technology.

FIG. 9 illustrates in-place updates for a software product, a patch plan with source locations and target locations file, and two memory buffers, in accordance with an embodiment of the disclosed technology.

FIG. 10 illustrates in-place updates for a software product, a patch plan with source locations and target locations file, and two memory buffers, in accordance with an embodiment of the disclosed technology.

FIG. 11 illustrates a set of source files with corresponding patch plans, in accordance with an embodiment of the disclosed technology.

FIG. 12 illustrates a transitive property of the in-place updates, in accordance with some embodiments of the disclosed technology.

FIG. 13 illustrates multiple sets of instructions, in accordance with some embodiments of the disclosed technology.

FIG. 14 is an example computing component that may be used to create a patch plan in accordance with an embodiment of the disclosed technology.

FIG. 15 illustrates an example flow chart and system architecture for implementing in-place updates in accordance with an embodiment of the disclosed technology.

FIG. 16 is an example computing component that may be used to implement various features of embodiments described in the present disclosure.

The figures are not exhaustive and do not limit the present disclosure to the precise form disclosed.

### DETAILED DESCRIPTION

As noted above, software products, including video games, can be distributed in the form of one or more files to computing devices, such as personal computers, smartphones, tablets, and video game consoles, among other systems of the like, via a CDN. Each of the one or more files may comprise or store therein, one or more binary resources (or simply, resources), such as executable code files, graphic assets, and software libraries, among other resources of the like.

A software product's lifecycle may include and/or produce multiple versions of the software product. In the context of a video game's lifecycle (which is also commonly referred to a “live service”), version updates to the video game introduce changes to one or more aspects of the video game such as gameplay feature updates, graphics updates, content updates, and other aspects of the like. Accordingly, as each version is released, the size, contents, or ordering of the one or more binary resources of the video game (e.g., as a software product) can change in relation to a previous version of a video game. A video game with “live services” generally requires updating, such that it can facilitate a uniform experience to users and players. Therefore, video games, as a software product, can include and require a number of version updates over the course of life cycle.

Accordingly, to keep a software product—such a video game—up-to-date, that software product may be updated or upgraded from a current or existing build level (or “version”) to a subsequent/target build level or version. Such a version upgrade typically involves updating the binary resources stored by the CDN. For example, each computing device that has the software product may perform updates of those computing device's locally stored binary files forming a current build of the software product. In this way, a software product (locally-installed on a computing device) can be built to the new version available from the CDN.

Since a typical software product update modifies a subset of the installed binary resources and/or introduces new binary resources, while re-using at least some portion of the installed binary resources, such incremental updates involve file “patching,” e.g., partially overwriting locally stored files with the content downloaded from a CDN in the form of fixed or variable size blocks. Various patching techniques attempt to identify reusable portions of the locally-installed software product build that may be utilized by the upgraded build. In certain implementations, the patching process involves identifying matching blocks of a determined size in the existing build and the new build, thus only downloading new or modified blocks.

However, version patching is generally performed at a computing device, which can be time-consuming, e.g., a user may wait several minutes before the downloading of actual patch data commences. For example, conventional patching techniques typically determine what to download by looking, at a time of update, what software (e.g., game) a computing device is currently running/has stored thereon, irrespective of version or other identifying information in/associated with software. This process occurs for every computing device for which an update is needed. Because such conventional methods are premised on scanning files and attempting to identify blocks in those files, the scanning process cannot be offloaded, from the computing device, to any other computing device or entity, such as a server. Additionally still, conventional patching techniques may involve the use of many calls to obtain portions or aspects of a synchronization package (i.e., an uncompressed version of a game build that includes additional metadata). These calls increase latency/incur processing costs, which can be problematic in a latency-sensitive CDN.

Additionally, as video game installation sizes increase, so does the amount of memory required by conventional patching techniques to update a video game from one version to another version, particularly when there are many changes to a video game between versions. This problem is further compounded when computing devices store many video games that require version updates, which further minimizes the amount of memory storage available performing version updates to a video game.

Thus, embodiments of the disclosed technology are directed to performing patch calculation and block scanning at a server or other location (e.g., a server of the CDN) to generate a patch plan. The details of the patch plan may specify a sequence of operations to be performed by the computing device in order to upgrade a locally-installed software product from a current build to a new build provided by the CDN. Additionally, once the new build is identified, the execution of the update can be performed in-place on the locally-installed software product. In other words, the current build at the computing device can be updated without creating a second copy of the locally-installed software product during the update process. Additionally, by utilizing the patch plan to perform the in-place update, version patching delays or latency at a computing device can be avoided.

In some examples, the updates to the current build may be simultaneously available at the CDN so that the source and target data location in the locally-installed software product can be identified prior to the in-place update. In contrast to the aforementioned conventional patching techniques, embodiments of the disclosed technology, as described herein, may utilize software/application version information that is embedded in the software, which allows the scanning to occur off/away from a computing device. The patch calculation described herein need only be performed once to create a source (current)-to-target version of the software product at the server side at the time of deployment to the CDN.

Further, the patch plan can be updated to avoid improperly overwriting reusable data from a source location to a target location in the locally-installed software product while performing the in-place update. In other words, only one file at the computing device may be used/updated as the software product absent replacing the software product as a whole. For example, the system may iteratively scan through copy operations in the patch plan and reorder the operations, such that the first copy operation moves a data block that is the closest to the beginning of the software product. If the target location for the data block is clear, the system may simply move the data block from the source location to the target location in accordance with the patch plan. However, if the target location is occupied by second data that needs to be reused (and not overwritten), the system may copy the second data to a memory buffer at the computing device to preserve the data, then perform the copy operation to the target location in the software product while the data is preserved in the memory buffer. By utilizing a memory buffer, the conflicts that would have been introduced by moving reusable data from a source location to a target location in-place at the software product, may be avoided. The updated patch plan can resolve any conflicts prior to performing the copy/overwrite operations.

In some examples, the patch plan may be separated into a first set of instructions (e.g., copy to) and a second set of instructions (e.g., copy from). The two sets of instructions may execute a recursive process that toggles between copying from/to locations in the software product to maintain the accuracy of the reusable data while also reordering the data at the target location. For example, the first set of instructions may be executed until the reusable data fills the memory buffer, then the second set of instructions may be executed to move the data from the memory buffer to the target locations in the software product. The recursive operation may continue to move back and forth between executing the sets of instructions defined by the patch plan until the source data has been moved to the target locations in the software product, absent overwriting reusable data or storing the reusable data in a second file. In this way, the patch plan, software product, and the memory buffer can help reduce memory allocated at the computing device to update the locally-installed software product in-place.

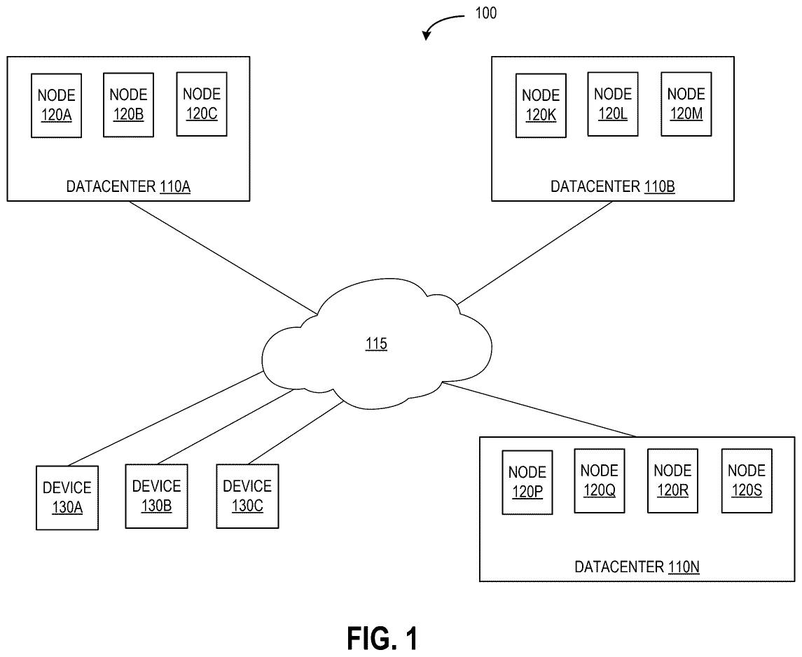

FIG. 1 is a schematic representation of a high-level, example CDN 100 operating in accordance with one or more aspects of the present disclosure. Computing devices, appliances, and network segments are shown in FIG. 1 for illustrative purposes only, and do not in any way limit the scope of the present disclosure. Various other computing devices, components, and appliances, and the like not shown in FIG. 1, and/or methods of their interconnection may be compatible with the methods and systems described herein. Various functional or auxiliary network components (e.g., firewalls, load balancers, network switches, user directories, content repositories, etc.) may be omitted from FIG. 1 for clarity.

In the example of FIG. 1, the CDN 100 may include content delivery nodes 120A-120S residing in multiple datacenters 110A-110N interconnected by one or more networks 115. In the example of FIG. 1, each cluster of content delivery nodes 120A-120S located in a datacenters 110A-110N collectively stores the full set of distribution files forming a current build of a software product to be distributed to the computing devices 130A-130C.

The datacenters 110A-110N may be geographically distributed in order to increase the overall throughput and reduce the network-related latency in servicing the requests, e.g., by redirecting each request to a datacenter which is located in a geographic proximity to the request-originating computing device. The CDN 100 may implement various load balancing mechanisms, cache coherence protocols and strategies, and/or other techniques aimed at improving the efficiency of the content distribution.

Distribution of binary resources to computing devices 130A-130C may involve receiving, by each of computing devices 130A-130C, build metadata utilized for creating a patch plan. Distribution may further involve creating a directory structure for the new build, creating empty files (e.g., with a predetermined filename extension, such as .patch) in the directory structure, and executing the patch plan that specifies a sequence of operations to be performed by the computing device in order to upgrade a locally installed software product from the current build to the new build level matching the latest build level available from the CDN. In certain implementations, executing the patch plan may involve moving resources from the current build into the new build locations within the created directory structure, downloading the missing resource data, copying at least some of the resources into secondary locations thus creating multiple instances of such resources in the new build, or renaming the patched files, and described in greater detail below.

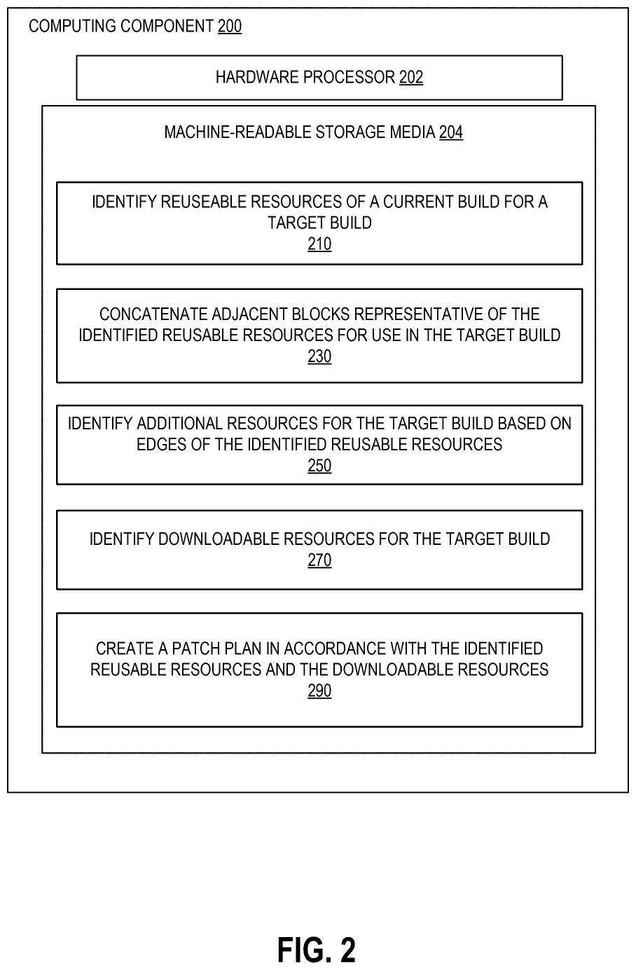

FIG. 2 illustrates an example computing component 200 that may be used to implement the creation of a patch plan in accordance with various embodiments of the disclosed technology to achieve in-place updates. Referring now to FIG. 2, computing component 200 may be, for example, a server computer (e.g., a server computing device), a controller, or any other similar computing component capable of processing data, e.g., at/in a CDN. In the example implementation of FIG. 2, computing component 200 includes hardware processor 202 and computer readable memory storage medium 204.

Hardware processor 202 may be one or more central processing units (CPUs), semiconductor-based microprocessors, and/or other hardware devices suitable for retrieval and execution of instructions stored in computer readable memory storage medium 204. Hardware processor 202 may fetch, decode, and execute instructions, such as instructions 210-290, to control processes or operations for creating a patch plan in accordance with in-place update systems and methods disclosed herein. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A computer readable memory storage medium, such as computer readable memory storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, computer readable memory storage medium 204 may be a non-transitory computer readable memory storage medium, where the term “non-transitory” does not encompass transitory propagating signals. As described in detail below, computer readable memory storage medium 204 may be encoded with executable instructions, for example, instructions 210-290.

Hardware processor 202 may execute instruction 210 to identify reusable resources of a current build for a target build. In some embodiments, a target build may comprise binary resources, and build metadata can, for each resource, specify a file in which the resource is stored, a resource offset within the file, the resource's size, and a hash(es) corresponding to the resource. As will be described in greater detail below, current build resources may be compared to target build resources. The comparison, performed using hash scans and a desired scan block size, identifies those resources in a current build that can be reused in the target build. As discussed above, embodiments of the disclosed technology are implemented at a server or other computing component/element that may not be a client computing device. Again, performing patching operations, such as determining reusable resources takes time when performed locally/at a computing device (waiting, e.g., several minutes before the downloading of actual patch data occurs). Moreover, scanning the current/target builds with smaller scan block sizes in accordance with embodiments of the disclosed technology, providing for more “accurate” determinations. That is, when scan block sizes are too large, as is the case with conventional implementations of patching, blocks corresponding to resources to be downloaded include data that need not be downloaded.

Hardware processor 202 may execute instruction 230 to concatenate adjacent blocks representative of the identified reusable resources for use in the target build. Concatenation (or merging) as referred to herein may comprise an operation(s) used to reduce the number of operations, e.g., copy operations, to copy a given range of bytes. The given range of bytes may correspond to a block(s) or a portion(s) of blocks of data representative of reusable binary resources, as will be described below. That is, adjacent blocks of data can be copied as a single, concatenated block, instead of copying two separate blocks of data using two, distinct copy operations.

Hardware processor 202 may execute instruction 250 to identify additional resources for the target build based on edges of the identified reusable resources. That is, after concatenating resources associated/represented by adjacent blocks in the target build, subsequent scanning of the edges/boundaries about the concatenated resources/resource blocks may be performed. For example, gaps in/adjacent to concatenated resource blocks, e.g., block edges, can be identified in the target build, and a re-scanning of the current build can be performed to determine if any additional resources may be reused. Such additional resources, if they exist, may be concatenated with a corresponding block to “grow” that block.

Hardware processor 202 may execute instruction 270 to identify downloadable resources for the target build. That is, any remaining blocks that have no “equivalent” source data (from the current build) will need to be downloaded from the CDN.

Hardware processor 202 may execute instruction 290 to create a patch plan in accordance with the identified reusable resources, and the downloadable resources. For example, bits corresponding to blocks of resources to be moved and/or bits to be downloaded are recorded. The bits to be downloaded may also be concatenated into a patch stream. It should be noted that some builds, e.g., for games, comprise builds for different languages that a game may support. That is, resources that are associated with/correspond to different languages, typically will not be patched together. Rather, the execution of the aforementioned instructions accounts for each language separately, where separate language streams are generated.

In some embodiments, a deduplication process may be performed. That is, and as noted above, all bits to be downloaded can be concatenated into a patch stream. When generating hash tables to map scan hash values to target block locations (described below), the server will know/can determine or identify whether a block(s) is used in multiple locations in a target file. When creating a patch plan, a first instance of a block to be downloaded is downloaded, and then copied to other location instances.

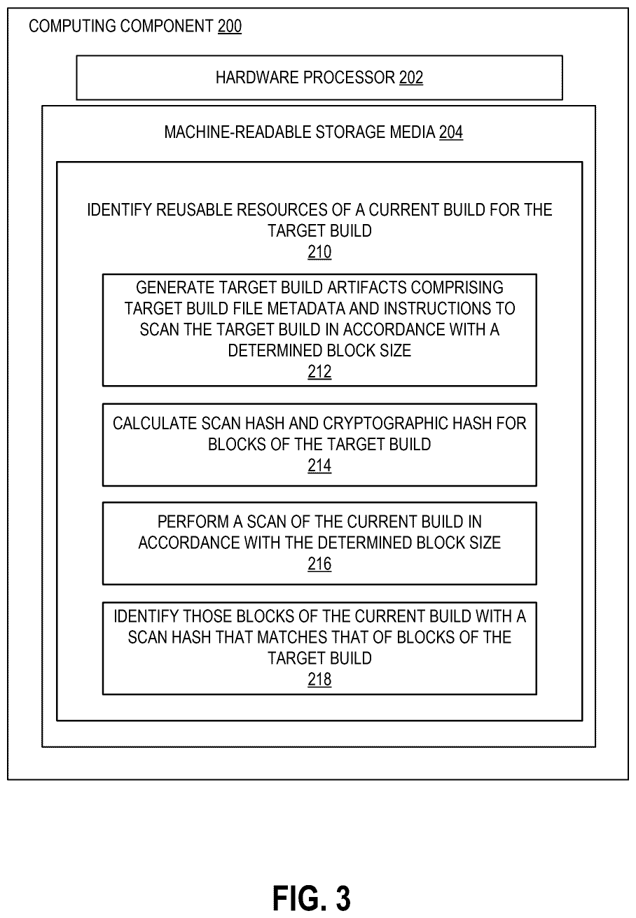

FIG. 3 illustrates the example computing component 200 (FIG. 2) that may be used to identify reusable resources of a current build for the target build. Computing component 200, hardware processor 202 and computer readable memory storage media 204 have been described/discussed above.

Hardware processor 202 may execute instruction 212 to generate target build artifacts comprising target build file metadata and instructions to scan the target build in accordance with a determined block size. For example, an “installer” artifact comprising a file may be generated, where the installer artifact file may contain metadata regarding the file(s) in a build, such as a game build. The metadata may include, but is not limited to, e.g., filename, file size, file hash (over a whole file for verification), a file data and any relevant locates (all languages to which a file belongs). If the locales metadata does not exist, the file is language agnostic.

Hardware processor 202 may execute instruction 214 to calculate scan and cryptographic hashes for blocks of the target build. Accordingly, another artifact, referred to as a blockinfo artifact, may be generated regarding hash information for each file in a build. Such an artifact may comprise a metadata file containing, e.g., block size information, hash algorithm (identification) information, and the block hashes of the target build file(s). Each block hash may comprise a scan hash, such as a Rabin Karp scan hash, and a cryptographic has, such as an MD5 or SHA1 has for match validation. It should be noted that typically, a scan hash can be performed quickly, but may lead to false matches, whereas a cryptographic hash (and a corresponding cryptographic hash check) can ensure or validate that a block identified as a match with the scan hash, can be confirmed by the cryptographic hash.

Based on the blockinfo artifact metadata, hash tables may be generated for each language and language-agnostic files of the target build. These hash tables comprise hash maps that associate scan hash information of the target build with blockinfo artifact data. That is, the hash maps can be loaded with the blockinfo data regarding the target build. All language-agnostic file data can be loaded in a “no languages” hash table, and all language-specific files data can be input into corresponding language hash tables. In this way, a mapping can be created between scan hash data and block locations in target build files.

Hardware processor 202 may execute instruction 216 to perform a scan of the current build in accordance with the determined block size. That is, the file(s) of a current build may be scanned with a scanning window having the determined block size. As mentioned above, a typical block size is larger than a block size contemplated for use in accordance with various embodiments of the disclosed technology. For example, a typical block size used for scanning is 64K, whereas smaller block sizes are contemplated in accordance with embodiments of the disclosed technology, e.g., on the order of 4K.

Hardware processor 202 may execute instruction 218 to identify those blocks of the current build with a scan hash value that matches the scan hash of blocks of the target build. As noted above, for each file in a target build, a blockinfo artifact is generated, where the blockinfo artifact comprises, in part, scan hash data for quick matching. If a match is discovered/identified, a cryptographic hash may be calculated to verify/confirm the scan hash-based match. If a match exists, the source file location corresponding to such matching block(s) is recorded into a copy operation array. In this way, a block array exists for each target build file(s) that indicates in what source file, and at what offset, a block that matches the target block may be found.

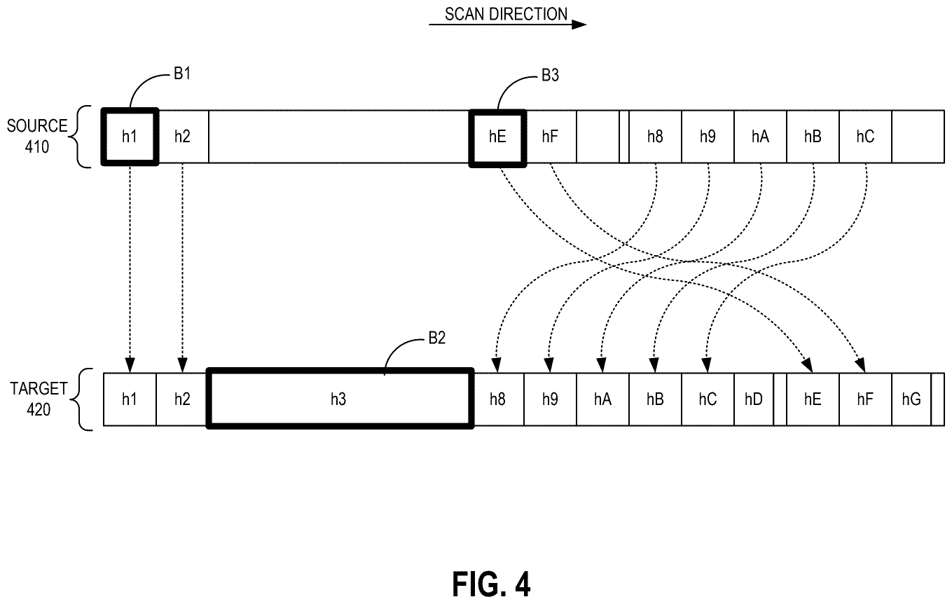

FIG. 4 illustrates an example scanning operation to identify reusable resources in accordance with an embodiment of the disclosed technology. FIG. 4 illustrates an example scanning scenario, where source build 410 exists for a current build/version of a locally-installed software product. Examples of software products include interactive videogames, e-commerce applications, and various other business and/or entertainment applications.

Source build 410 may be scanned to identify any resource that matches with target build 420. The number of source/target files that make up a current/target build, respectively, may vary. Scanning may comprise iterating through blocks of a defined size of a file(s) of source build 410 or target build 420. The scanning may proceed through data h1, h2, h8, h9, hA, hB, hC, hE, and hF in source build 410. The data may comprise binary resources, such as executable code files, data files, graphic assets (e.g., textures, still images, fonts, animated images, video streams), multimedia assets, sound streams, etc.

The windowed scan of source build 410 of the software product is as follows. In the scan direction, it can be appreciated that the resources/data in source build 410 of a current build having the following hash values match those of target build 420 (and thus can be reused): h1, h2, h8, h9, hA, hB, hC, hE, and hF.

Block window B1 illustrates how a reduced size results in most scanned blocks being singular blocks, with few scans spanning multiple blocks (avoiding certain aforementioned disadvantages of conventionally-implemented version patching). In other words, and as discussed above, smaller block sizes aid in the identification of more binary resource matches between source and target versions of software, because the use of larger blocks may result in identifying matching blocks, but the corresponding resources may not match. Moreover, smaller block sizes tend to reduce the identification of un-matchable blocks at resource boundaries if the resource ordering isn't the same in a source file as it is in a target file, or between differently-named files. The “growing” of blocks, e.g., identifying additional reusable resources at block edges effectively eliminates most losses in these areas/in such scenarios.

Block window B2 illustrates new data in the target software build that can be added in accordance with the patch plan. The data may be downloaded (e.g., as additional metadata) and included with the locally-installed software product in response to the in-place update process. In this example, any resources of the target build (i.e., resources of the target build for which corresponding resources of the current build do not exist or cannot be reused without at least some modifications due to the hash mismatch, e.g., such as resources h3, hD, and hG) may be downloaded from the CDN. Alternatively, block scanning may be performed again in order to identify any blocks which can be reused for the new or modified resources.

Block window B3 illustrates reusable data that can be moved from a source location to a target location in the locally-installed software product. The location between the source location and the target location may be identified in response to the in-place update process. It should also be noted that any differences between the order and/or offsets of resources between source and target files does not impact the determination of resource matches. Again, embodiments of the disclosed technology rely on hash values provided by build data. For example, it can be appreciated that the order of matching resources h8, h9, and hA-hF differs between source build 410 and target build 420 of the locally-installed software product.

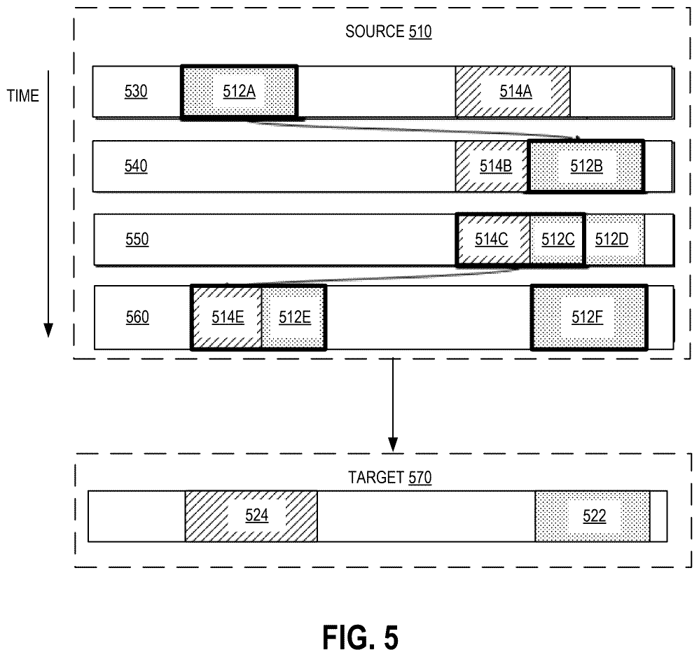

FIG. 5 illustrates an in-place update operation with a source location and target location. For example, source data may be moved/stored from a source location to a target location in a software product. In some examples, the source data may overwrite data at a second location of the locally-installed software product when the data is intended to be maintained/reused. The data may be corrupted at the second location and unable to be reused after execution of the in-place update process.

For example, source 510 comprises first data 512 and second data 514 through a progression of time as the data are stored as bits to make up a locally-installed software product (e.g., on a memory disk). First data 512 and second data 514 may be copied and stored at different locations in source 510 at different points in time. As illustrated herein, first data 512 may be illustrated as first data 512A, first data 512B, first data 512C, first data 512D, first data 512E, and first data 512F to identify the memory location of first data 512 at different points in time, and second data 514 may be illustrated as second data 514A, second data 514B, second data 514C, and second data 514E to identify the memory location of second data 514 at different points in time. Target 570 may comprise an intended outcome of first data 512 and second data 514, illustrated as first data 522 and second data 524.

At time 530, first data 512A and second data 514A define a locally-installed software product as its source definition. First data 512A and second data 514A may be placed at source 510 locations of the software product prior to any in-place updates of the software product in accordance with the patch plan.

At time 540, first data 512A are moved to a second location in source 510 and stored as first data 512B. Second data 514B remains stored in source 510. In this example, the second location in source 510 to store first data 512B overlaps with the original location of second data 514B and is partially overwritten on disk.

At time 550, the patch plan identifies a memory location in source 510 where second data 514C would have been stored, absent the overwriting operation of first data 512B. In this example, the system identifies the memory location in source 510 as comprising a portion of second data 514C that remains and also a subset of first data 512C that has overwritten second data 514C.

At time 560, the system moves/stores the portion of second data 514E and the subset of first data 512E to the new location in source file 510. First data 512F may continue to be stored in the first location (e.g., on a memory disk) in source 510. In some examples, the first memory location of first data 512F may be deleted from source 510, without diverting from the essence of the disclosed technology.

In response to the copying and storing operations illustrated herein, source 510 may comprise different data than what was identified in the patch plan and intended for the in-place update of the software product. As such, second data 514E and the subset of first data 512E do not match second data 524 intended for target 570. The memory locations of first data 522 and second data 524 in target 570 may differ from the original memory locations of first data 512A and second data 514A in source 510, while also failing to match the intended data locations in the patch plan.

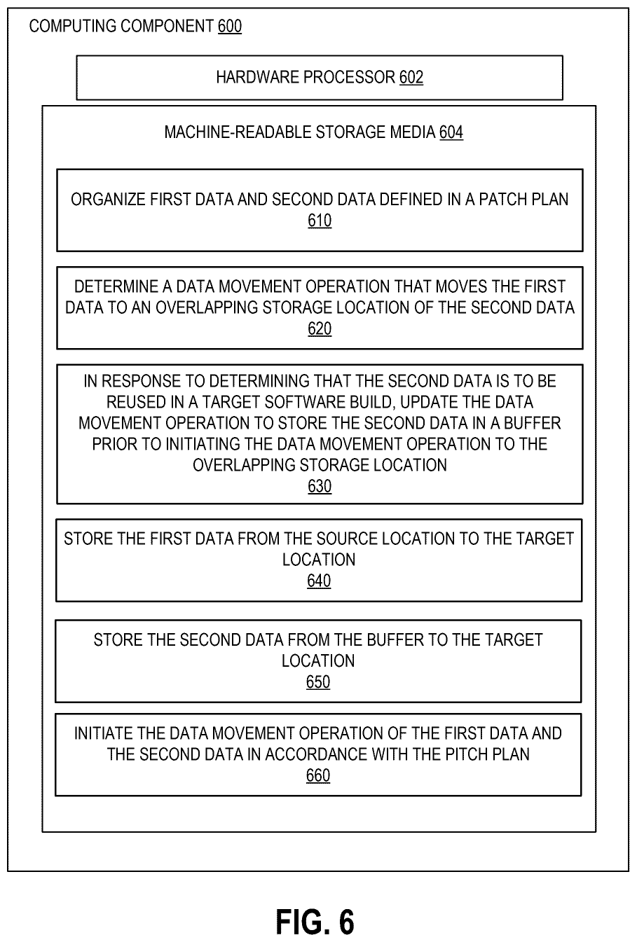

FIG. 6 illustrates an example computing component 600 that may be used to implement in-place updates in accordance with various embodiments of the disclosed technology. Referring now to FIG. 6, computing component 600 may be, for example, a server computer, a controller, or any other similar computing component capable of processing data, e.g., at/in a CDN. In the example implementation of FIG. 6, computing component 600 includes a hardware processor 602 and computer readable memory storage medium 604.

Hardware processor 602 may be one or more central processing units (CPUs), semiconductor-based microprocessors, and/or other hardware devices suitable for retrieval and execution of instructions stored in computer readable memory storage medium 604. Hardware processor 602 may fetch, decode, and execute instructions, such as instructions 610-660, to control processes or operations for implementing in-place updates in accordance with systems and methods disclosed herein. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A computer readable memory storage medium, such as computer readable memory storage medium 604, may be any electronic, magnetic, optical, or other physical storage device that contains or stores executable instructions. Thus, computer readable memory storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, computer readable memory storage medium 604 may be a non-transitory computer readable memory medium, where the term “non-transitory” does not encompass transitory propagating signals. As described in detail below, computer readable memory storage medium 604 may be encoded with executable instructions, for example, instructions 610-660.

In some examples, instructions 610-660 may be preceded by and incorporated with one or more of a subset of instructions 210-290 illustrated in FIG. 2. For example, the instructions illustrated in FIG. 2 may be executed to create a patch plan in accordance with an embodiment of the disclosed technology.

Hardware processor 602 may execute instruction 610 to organize first re-usable data and second reusable data in a patch plan. The patch plan may define data movement and storage operations to update a current software build of a locally-installed software product to a target software build. As discussed herein, the reusable data may correspond to blocks of data that can be moved in response to modifications or adjustments between the source locations in the software product and the target locations. The reusable data may be moved in-place within the software product file. The software build may put together these blocks of data to build the software product.

In some examples, a current/existing patch plan may be used to organize the first reusable data and second reusable data within the locally-installed software product. The organization of the patch plan may identify which blocks can be reused, a location in the source file where the block of data is originally located, a location in the target file where the block of data will be moved, and any other movement/changes in response to the update.

Hardware processor 602 may execute instruction 620 to determine a data movement operation that moves the first reusable data to an overlapping storage location of the second reusable data. For example, the instruction may identify the location in the target file where the block of data will be moved and also identify that a second block of data is currently stored in the same location in the software product. The identification of the overlapping storage location of the second reusable data may be identified during a review of the patch plan that defines the data movement and storage operations to update a current software build to a target software build.

Hardware processor 602 may execute instruction 630 to, in response to determining that the second reusable data is to be reused in the target software build, update the data movement operation to store the second reusable data in a memory buffer prior to initiating the data movement operation to the overlapping storage location.

The update may correspond to a recursive process. For example, when the first reusable data is determined to be moved to an overlapping location with second reusable data, the recursive process can identify the movement operations that would overwrite a portion of the reusable data in accordance with the original patch plan and redirect the movement instruction to copy the data to a memory buffer prior to copying the data to the target location. In this example, the second reusable data may be located in the intended target location of the first reusable data. The second reusable data can be moved to a memory buffer to maintain the accuracy of the second reusable data and avoid overwriting it with the first reusable data. Once the second reusable data has been moved to the memory buffer, the first reusable data can be moved to the target location and the second reusable data can be moved to its target location. Thus, with the help of the memory buffer, the recursive process can help prevent data obstruction through conflicting storage locations.

Hardware processor 602 may execute instruction 640 to store the first reusable data from the source location to the target location. For example, the second reusable data may be stored in the memory buffer and the process can overwriting the second reusable data absent a backup copy, which would have been previously stored in the memory buffer. As such, the movement operation of the second reusable data can maintain the accuracy of the second reusable data and also allow the first reusable data to be moved to the correct target location during an in-place update.

Hardware processor 602 may execute instruction 650 to store the second reusable data from the memory buffer to the target location. In the example where the second reusable data is stored in an overlapping target location with a third reusable data, the recursive process may first store the reusable data that is currently stored at the overlapping location in a memory buffer, then move the second reusable data from the memory buffer to the target location. As such, the recursive process and movement can maintain the accuracy of several reusable data to the correct target locations.

Hardware processor 602 may execute instruction 660 to initiate the data movement operation of the first reusable data and second reusable data in accordance with the patch plan.

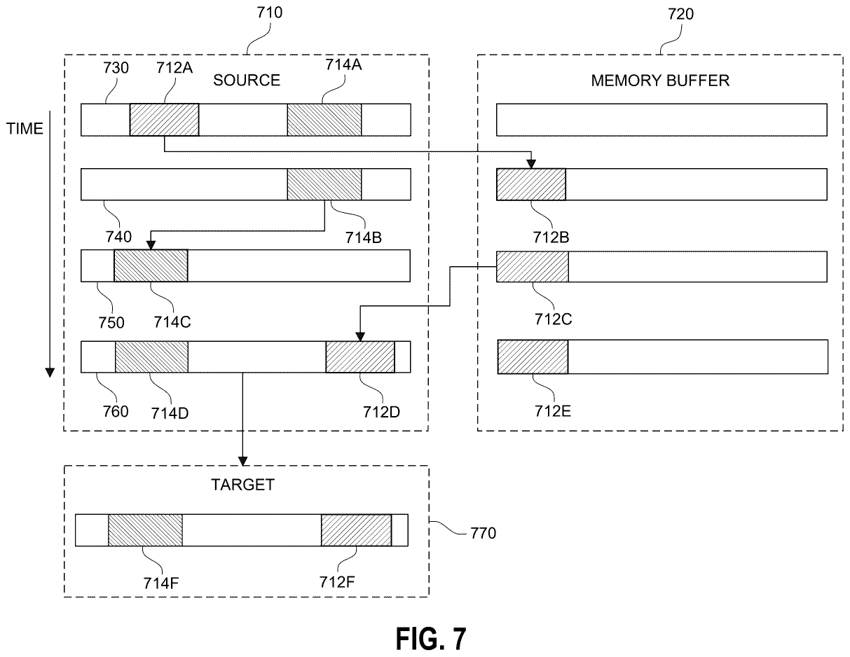

FIG. 7 illustrates in-place updates with a software product, a patch plan with source locations and target locations, and a memory buffer, in accordance with an embodiment of the disclosed technology. For example, source data may be moved/stored from a source location to a memory buffer, then a copying/moving operations can be initiated to move the data from the memory buffer to a target location. This can allow the system to write the data of the original source location into its target location without overwriting the data and corrupting it.

Source 710 comprises first data 712 and second data 714 through a progression of time as the data are stored as bits in a memory store (e.g., memory disk). First data 712 and second data 714 may be copied and stored between source 710 and a single memory buffer 720 at different points in time. As illustrated herein, first data 712 may be illustrated as first data 712A, first data 712B, first data 712C, first data 712D, first data 712E, and first data 712F to identify the memory location of first data 712 at different points in time, and second data 714 may be illustrated as second data 714A, second data 714B, second data 714C, second data 714D, and second data 714F to identify the memory location of second data 714 at different points in time.

At time 730, first data 712A and second data 714A are stored in source 710 and not stored in memory buffer 720. First data 712A and second data 714A may be placed at source 710 locations of the software product prior to any in-place updates of the software product in accordance with the patch plan.

At time 740, first data 712A are moved to memory buffer 720 and stored as first data 712B. Second data 714B remains stored in source 710 and not stored in memory buffer 720.

At time 750, second data 714C are moved/stored at a second/different location in source 710. The first memory location of second data 714B may remain unchanged and may continue to be stored in the first location (e.g., on a memory disk). In some examples, second data 714B may be deleted from source 710 without diverting from the essence of the disclosed technology.

At time 760, first data 712D are moved from memory buffer 720 to a second/different location in source 710. The location in memory buffer 720 of first data 712C may continue to be stored in the memory buffer 720. In some examples, first data 712E may be deleted from memory buffer 720 without diverting from the essence of the disclosed technology.

In response to the copying and storing operations illustrated herein, target 770 may comprise first data 712F and second data 714F. The memory locations of first data 712F and second data 714F in target 770 may differ from the original memory locations of first data 712A and second data 714A in source 710.

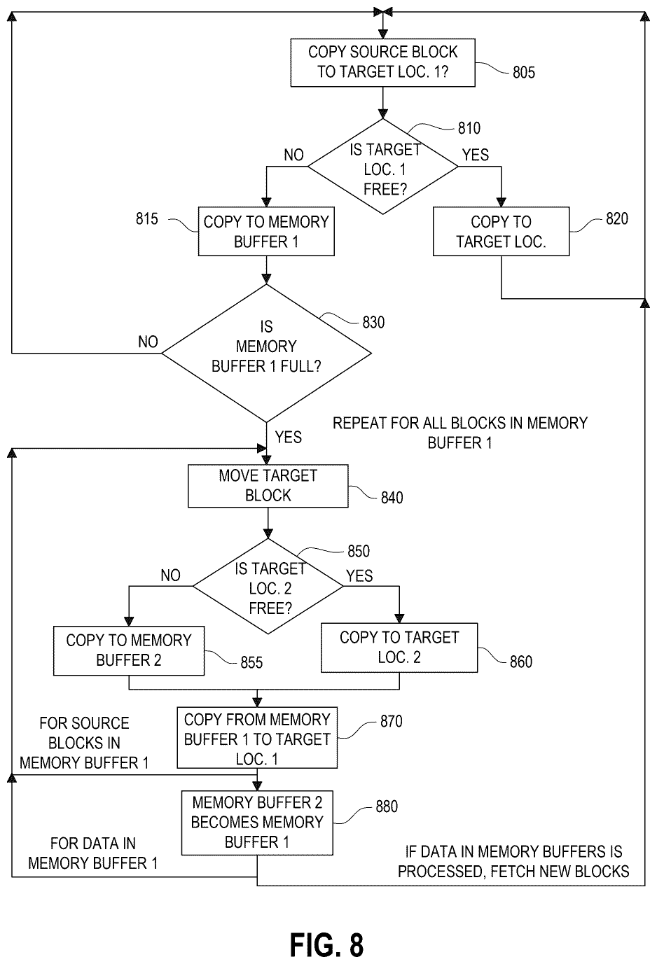

FIG. 8 is an illustrative process for implementing in-place updates for a software product, a patch plan with source locations and target locations file, and two memory buffers, in accordance with an embodiment of the disclosed technology. In this example, the patch plan may have been created to define a set of data movement and storage operations to update a current software build to a target software build. When the patch plan includes a data movement operation that moves first reusable data to an overlapping storage location of second reusable data and the second reusable data is to be reused in the target software build, the patch plan or corresponding process may be updated to avoid overwriting the reusable data, as shown herein.

At block 805, the process may determine that the patch plan includes an instruction to copy the source data to a first target location.

At block 810, the process may determine if the first target location is available/free. This can avoid the process overwriting data that could be reusable in the target software build. In determining whether the first target location is available, the process may identify whether any data stored in the first target location is reusable in the target software build (e.g., accordance with the patch plan). If the first target location is not available, the process may proceed to block 815. If the first target location is available, the process may proceed to block 820.

At block 815, the process may copy the source data to a first memory buffer (e.g., when the first target location is unavailable or the data stored in the first target location is reusable in the target software build).

At block 820, the process may copy the source data to the first target location (e.g., when the first target location is available/empty or when the data stored in the first target location is not used in the target software build).

At block 830, the process may determine if the first memory buffer is full or determine if all of the source data has been copied to the first memory buffer. The first memory buffer may be full when the data stored in the first memory buffer has not been copied to a target location in a target software build yet. The first memory buffer may be available when the data stored in the first memory buffer has been copied to a target location and can be overwritten. If the first target location is not full or more source data is available to copy, the process may proceed to block 840. If the first target location is full or no more source data is available to copy, the process may proceed to block 805.

In some examples, the process may iteratively repeat block 830 for multiple data blocks located in the first memory buffer. For example, the process may continue to identify data blocks in the first memory buffer until each of the reusable memory blocks have been moved to target locations and can be overwritten in the first memory buffer.

At block 840, the process may move the target data located at the first target location out of its current location. The process may determine if the target data can be moved to a second target location (block 860) or a second memory buffer (block 855).

At block 850, the process may determine if the second target location is available/free. If the second target location is not available, the process may proceed to block 855 to copy the reusable data to the second memory buffer. If the second target location is available, the process may proceed to block 860 to copy the reusable data to the second target location.

At block 870, the process may copy the data from the first memory buffer to the first target location. In some examples, the process may iteratively repeat block 870 for multiple data blocks located in the first memory buffer.

At block 880, the process may identify the second memory buffer as the first memory buffer, as long as there is data in the first memory buffer. If no data are stored in the first memory buffer or the second memory buffer, the process may fetch new data blocks and return to block 805.

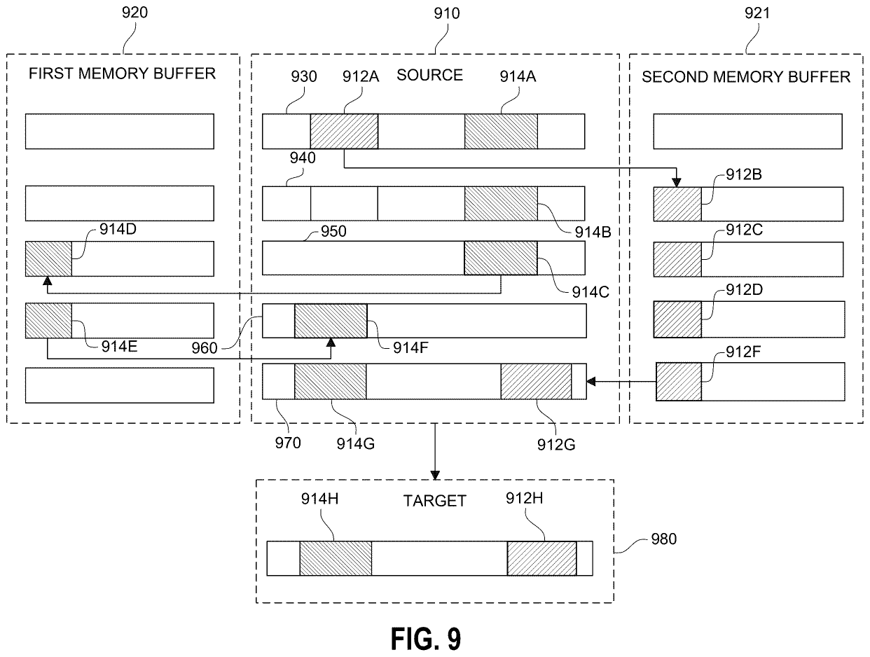

FIG. 9 illustrates in-place updates with a software product, a patch plan with source locations and target locations, and two memory buffers, in accordance with an embodiment of the disclosed technology. For example, source data may be moved/stored from a source location to more than one memory buffer, then copying/moving operations can be initiated to move it from the memory buffer to the target location. This can allow the system to write the data of the original source location into its target location without overwriting the data and corrupting it.

Source 910 comprises first data 912 and second data 914 through a progression of time as the data are stored as bits in a memory store (e.g., memory disk). First data 912 and second data 914 may be copied and stored between source 910 and a set of memory buffers 920, 921 at different points in time. In some examples, the set of memory buffers 920, 921 may be implemented as a single memory buffer without diverting from the essence of the disclosed technology.

As illustrated herein, first data 912 may be illustrated as first data 912A, first data 912B, first data 912C, first data 912D, first data 912F, first data 912G, and first data 912H to identify the memory location of first data 912 at different points in time, and second data 914 may be illustrated as second data 914A, second data 914B, second data 914C, second data 914D, second data 914E, second data 914F, second data 914G, and second data 914H to identify the memory location of second data 914 at different points in time.

At time 930, first data 912A and second data 914A are stored in source 910 and not stored in first memory buffer 920 or second memory buffer 921. First data 912A and second data 914A may be placed at source 910 locations of the software product prior to any in-place updates of the software product in accordance with the patch plan.

At time 940, first data 912A are moved to second memory buffer 921 and stored as first data 912B. Second data 914B remains stored in source 910 and not stored in second memory buffer 921. The first memory location of first data 912A may continue to be stored in the first location (e.g., on a memory disk). In some examples, first data 912A may be deleted from source 910 without diverting from the essence of the disclosed technology.

At time 950, second data 914C are moved to first memory buffer 920 and stored as second data 914D. First data 912C may remain stored in second memory buffer 921. The first memory location of second data 914C may continue to be stored in the first location (e.g., on a memory disk). In some examples, second data 914C may be deleted from source 910 without diverting from the essence of the disclosed technology.

At time 960, second data 914E are moved from first memory buffer 920 to a second/different location in source 910 and stored as second data 914F. First data 912D may remain stored in second memory buffer 921.

At time 970, first data 912F are moved from second memory buffer 921 to a second/different location in source 910 and stored as first data 912G.

In response to the copying and storing operations illustrated herein, target 980 may comprise first data 912H and second data 914H. The memory locations of first data 912H and second data 914H in target 980 may differ from the original memory locations of first data 912A and second data 914A in source 910.

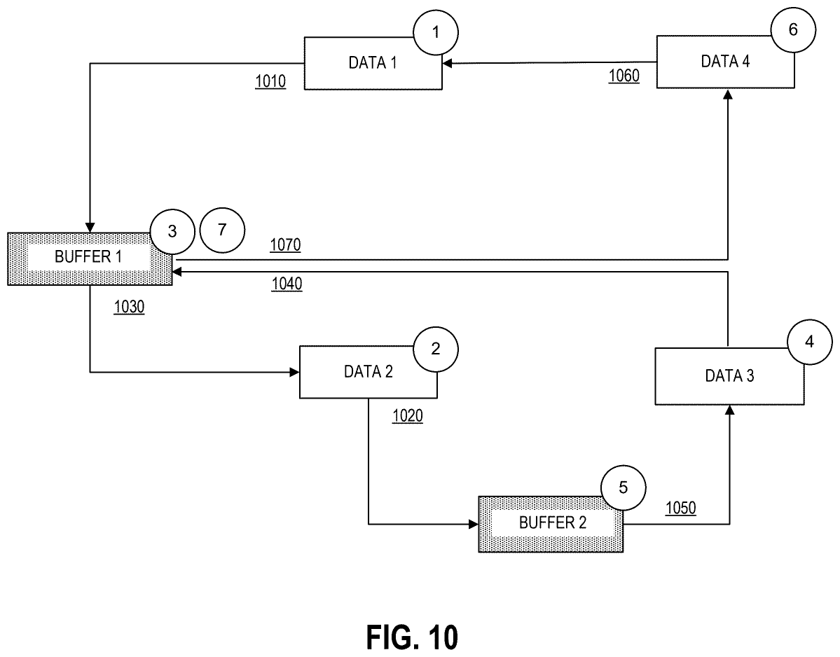

FIG. 10 illustrates in-place updates for a software product, a patch plan with source locations and target locations file, and two memory buffers, in accordance with an embodiment of the disclosed technology. In some examples, a patch plan may have been previously created and the movement of data between locations in the source and target locations may be identified in response to executing the corresponding patch plan.

At block 1010, the process may copy the first data from a first source location to a first memory buffer.

At block 1020, the process may copy the second data from a second source location to second memory buffer.

At block 1030, the process may copy the first data from the first memory buffer to the second source location, which can correspond to the target location for the first data in the target software build. The data previously stored in the second source location may have been copied to the second memory buffer at block 1020 and, although the second data may be reused in the target software build, it may remain usable by temporarily storing it in the second memory buffer prior to moving the second data to its target location in the target software build.

At block 1040, the process may copy the third data from the third source location to the first memory buffer. The data previously stored in the first memory buffer may have been copied to the second source location so that it can remain usable in the target software build absent overwriting it in the third source location or the first memory buffer.

At block 1050, the process may copy the second data from the second memory buffer to the third source location, which can correspond to the target location for the second data in the target software build. The data previously stored in the third source location may have been copied to the first memory buffer so that it can remain usable in the target software build.

At block 1060, the process may copy the fourth data from the fourth source location to the first source location.

At block 1070, the process may copy the third data from the first memory buffer to the fourth source location, which can correspond to the target location for the third data in the target software build. The data previously stored in the fourth source location may have been copied to the first source location at block 1060 and, although the third data and fourth data may be reused in the target software build, the third data may remain usable by temporarily storing it in the first memory buffer to avoid being overwritten.

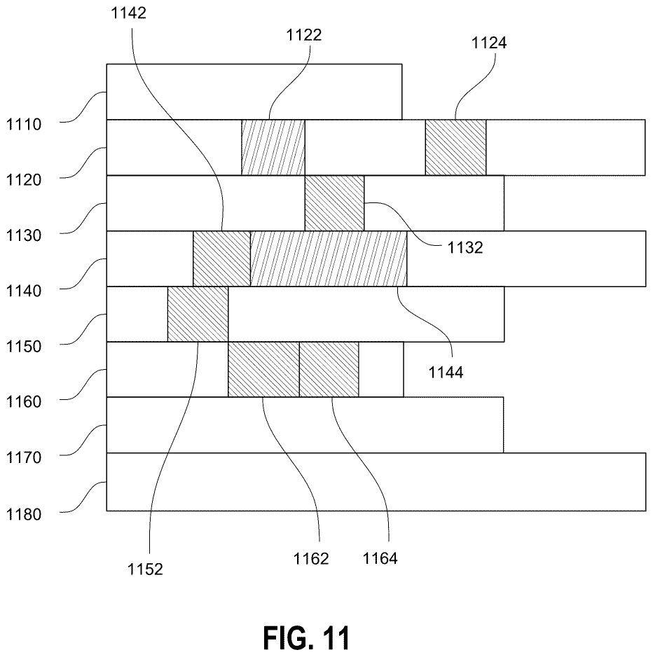

FIG. 11 illustrates a set of source files with corresponding patch plans, in accordance with an embodiment of the disclosed technology. In this example, a set of source files are identified, including source file 1110, 1120, 1130, 1140, 1150, 1160, 1170, and 1180. The system may receive the source files and organize reusable data in accordance with the patch plan to help define the data movement and storage operations that can update a source software build to a target software build.

In response to a review of the original patch plan, the system can identify reusable data that may either be moved to a location that overlaps with other reusable data or may move to a location that does not overlap. Reusable data that does not overlap may correspond to data 1122 in source file 1120 and data 1144 in source file 1140. For these data, the target location is available and is not planned to overwrite other reusable data. As such, data 1122 and data 1144 may be moved to the target location absent first copying the data to a memory buffer.

The reusable data overlaps with a location of other reusable data may correspond to data 1124 in source file 1120, data 1132 in source file 1130, data 1142 in source file 1140, data 1152 in source file 1150, and data 1162, 1164 in source file 1160. For these data, the target location is not available because the original patch plan would instruct the system to overwrite the reusable data in its original/source location with other reusable data. As such, these data are moved to the memory buffer first, then moved from the memory buffer to the target location.

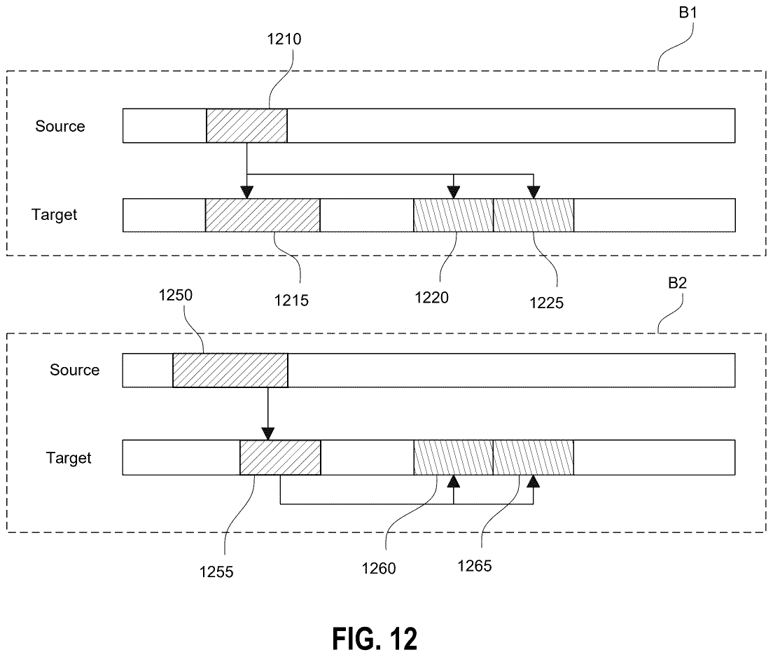

FIG. 12 illustrates a transitive property of the in-place updates, in accordance with some embodiments of the disclosed technology. In this example, in-place update operations B1, B2 may be equal in the target locations where the data are moved. In these examples, the copies of data from source locations 1210 and 1250 to target locations 1215, 1220, 1225, 1255, 1260, and 1265, respectively, may be created in response to executing the patch plan.

For example, in B1, data 1210 may be moved from source location in current/source software product to three target locations in the updated software product, including locations 1215, 1220, 1225. In B2, data 1250 may be moved from source location in current/source software product to one target location 1255 in the updated software product. A second, recursive operation (e.g., during replanning) may be performed that copies the data from the first target location 1255 to different target locations, including locations 1260, 1265.

In some examples, target location 1255 may correspond to a memory buffer location. As such, data 1250 may be moved in the software product to the memory buffer, then moved from the memory buffer to different target locations, including locations 1260, 1265.

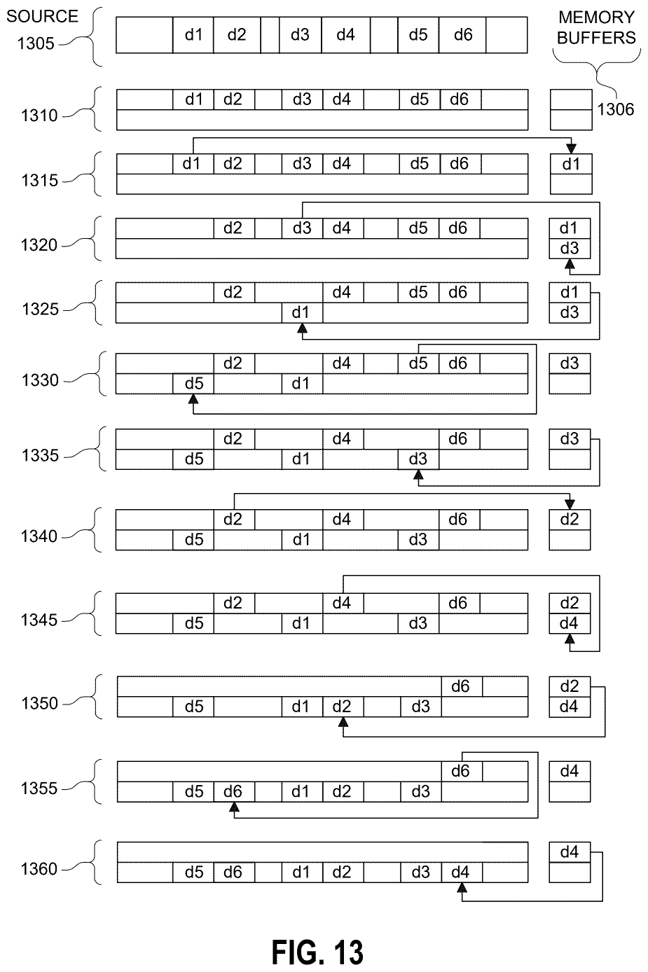

FIG. 13 illustrates multiple sets of instructions, in accordance with some embodiments of the disclosed technology. For example, the patch plan may be separated into a first set of instructions (e.g., copy to) and a second set of instructions (e.g., copy from). The two sets of instructions may execute a recursive process toggles between copying from/to locations in the software product to maintain the accuracy of the reusable data while also reordering the data at the target location.

In this example, source 1305 and memory buffers 1306 are illustrated with multiple sets of instructions that may be executed to move the data d1, d2, d3, d4, d5, and d6. The data may be moved in-place at the software product. For example, the first set of instructions may move the reusable data from source 1305 to memory buffers 1306, then the second set of instructions may be executed to move the data from memory buffers 1306 to the target locations in the software product. The recursive operation may continue to move the data back and forth based on executing the sets of instructions defined by the patch plan until the source data has been moved to the target locations in the software product, absent overwriting reusable data or storing the reusable data in a second file.

At block 1310, reusable data d1, d2, d3, d4, d5, and d6 are provided at source 1305 locations in the software product. Memory buffers 1306 are available to receive reusable data from source 1305 and store the data to later copy the data to target locations in the software product.

At block 1315, reusable data d1 are moved from source 1305 location to a memory buffer 1306. The reusable data d1 may be reusable at a target location in the software product.

At block 1320, reusable data d3 are moved from source 1305 location to a memory buffer 1306. Reusable data d3 may be reusable at a target location in the software product.

At block 1325, reusable data d1 are moved back from the memory buffer 1306 to a destination location. Reusable data d3 may remain in the memory buffer 1306.

At block 1330, reusable data d5 are moved from the source location to a target location in the software product. In this example, the target location may be open and available to accept reusable data d5, since the first reusable data d1 were previously copied to the memory buffer.

At block 1335, reusable data d3 are moved from the memory buffer to a target location in the software product. In this example, the target location may be open and available to accept reusable data d3, since reusable data d5 were previously copied to the target location.

At block 1340, reusable data d2 are moved from the source location to the memory buffer.

At block 1345, reusable data d4 are moved from the source location to the memory buffer.

At block 1350, reusable data d2 are moved from the memory buffer to the target location.

At block 1355, reusable data d6 are moved from the source location to the target location.

At block 1360, reusable data d4 are moved from the memory buffer to the target location.

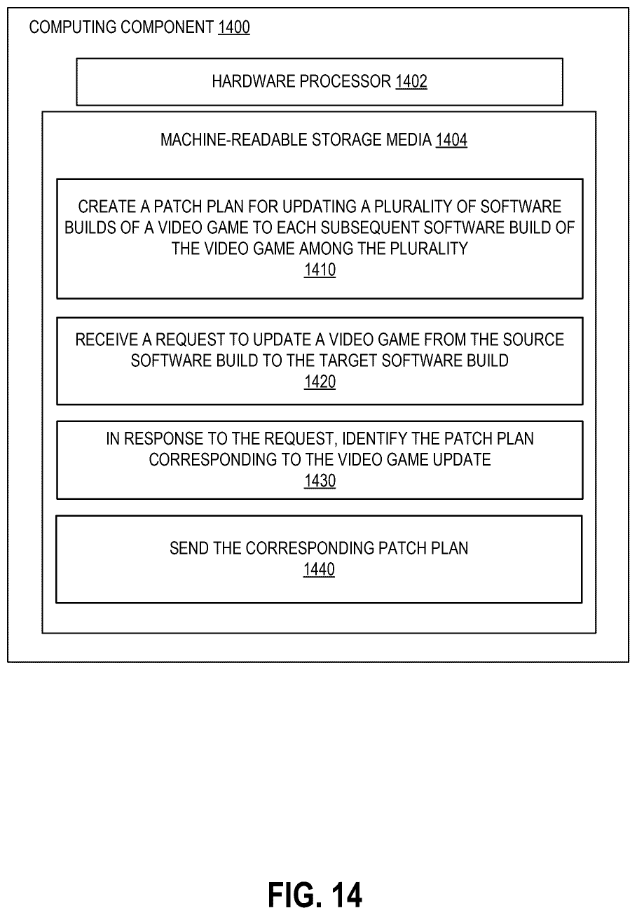

FIG. 14 is an example computing component 1400 that may be used to implement the creation of a patch plan in accordance with various embodiments of the disclosed technology to achieve in-place updates. Referring now to FIG. 14, computing component 1400 may be, for example, a server computer (e.g., a server computing device), a controller, or any other similar computing component capable of processing data, e.g., at/in a CDN. In the example implementation of FIG. 14, computing component 1400 includes hardware processor 1402 and computer readable memory storage medium 1404.

Hardware processor 1402 may be one or more central processing units (CPUs), semiconductor-based microprocessors, and/or other hardware devices suitable for retrieval and execution of instructions stored in computer readable memory storage medium 1404. Hardware processor 1402 may fetch, decode, and execute instructions, such as instructions 1410-1440, to control processes or operations for creating a patch plan in accordance with in-place update systems and methods disclosed herein. As an alternative or in addition to retrieving and executing instructions, hardware processor 1402 may include one or more electronic circuits that include electronic components for performing the functionality of one or more instructions, such as a FPGA, ASIC, or other electronic circuits.

A computer readable memory storage medium, such as computer readable memory storage medium 1404, may be any electronic, magnetic, optical, or other physical storage device that contains or stores executable instructions. Thus, machine-readable storage medium 1404 may be, for example, RAM, NVRAM, EEPROM, a storage device, an optical disc, and the like. In some embodiments, computer readable memory storage medium 1404 may be a non-transitory computer readable memory storage medium, where the term “non-transitory” does not encompass transitory propagating signals. As described in detail below, computer readable memory storage medium 1404 may be encoded with executable instructions, for example, instructions 1410-1440.

Hardware processor 1402 may execute instruction 1410 to create a patch plan for updating a plurality of software builds of a video game to each subsequent software build of the video game among the plurality of software builds.

In some examples, the patch plan may identify reusable resources of the target software build of the video game. In some embodiments, a target software build may comprise binary resources, and build metadata can, for each resource, specify a file in which the resource is stored, a resource offset within the file, the resource's size, and a hash(es) corresponding to the resource. In some examples, current build resources may be compared to target build resources. The comparison, performed using hash scans and a desired scan block size, identifies those resources in a current software build that can be reused in the target software build.

In some examples, the patch plan may concatenate adjacent blocks representative of the identified reusable resources for use in the target software build. For example, the concatenation may comprise an operation(s) used to reduce the number of operations, e.g., copy operations, to copy a given range of bytes. The given range of bytes may correspond to a block(s) or a portion(s) of blocks of data representative of reusable binary resources, as will be described below. That is, adjacent blocks of data can be copied as a single, concatenated block, instead of copying two separate blocks of data using two, distinct copy operations.

In some examples, the patch plan may identify additional resources for the target software build based on edges of the identified reusable resources. That is, after concatenating resources associated/represented by adjacent blocks in the target build, subsequent scanning of the edges/boundaries about the concatenated resources/resource blocks may be performed. For example, gaps in/adjacent to concatenated resource blocks, e.g., block edges, can be identified in the target build, and a re-scanning of the current build can be performed to determine if any additional resources may be reused. Such additional resources, if they exist, may be concatenated with a corresponding block to “grow” that block.

In some examples, the patch plan may identify downloadable resources for the target software build. That is, any remaining blocks that have no “equivalent” source data (from the current build) will need to be downloaded from the CDN.

In some examples, the patch plan may create the patch plan in accordance with the identified reusable resources and the downloadable resources. For example, bits corresponding to blocks of resources to be moved and/or bits to be downloaded are recorded. The bits to be downloaded may also be concatenated into a patch stream. It should be noted that some builds, e.g., for games, comprise builds for different languages that a game may support. That is, resources that are associated with/correspond to different languages, typically will not be patched together. Rather, the execution of the aforementioned instructions accounts for each language separately, where separate language streams are generated.

Hardware processor 1402 may execute instruction 1420 to receive a request to update a video game from the source software build to the target software build. For example, a computing device (e.g., a computing device that includes the video game) may request data to update a current build/version to a new/target build or version of software. The patch plan for the video game may be generated for in-place updates without a “back” patch being generated. As such, the patch plan may correspond with a new/target build or version of software to replace the software product (e.g., as a patch stream).

Hardware processor 1402 may execute instruction 1430 to identify the patch plan corresponding to the video game update in response to the request. For example, in response to receiving the request, the processor can identify the patch plan corresponding to the request and, in some examples, the URL corresponding to the appropriate patch plan. In some examples, the patch plan is identified in a catalog with a date (or date/time) when the new build will be “live,” e.g., available for download.

Hardware processor 1402 may execute instruction 1440 to send the corresponding patch plan. For example, the URL corresponding to the appropriate patch plan can be provided, together with any relevant patch streams. In some examples, a coordinator may listen for the update to the date in the catalog corresponding to the new patch plan. Upon sensing or discovering update, the coordinator may instruct a computing device to download the new (published) build or push/transmit the build to the computing device directly.

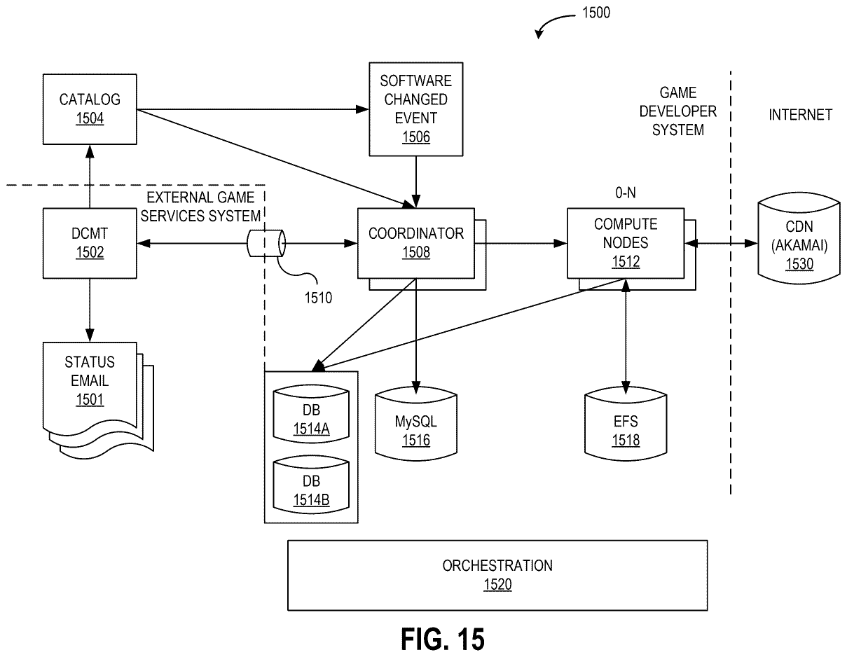

FIG. 15 illustrates an example system architecture 1500 for implementing in-place updates in accordance with an embodiment of the disclosed technology. The dotted lines delineate boundaries between an “internal” game developer system (comprising services/functionality directed to game developers and to a game development company internal personnel), an “external game services system (comprising services/functionality directed to users/players of games), and the Internet or other network of which CDN 1530 is a part.

When a new game build/version is to be published, the developer/game development team, operating in an external game services system portion of system 1500, may publish such a build to CDN 1530, which in some implementations may be a cloud network provided/hosted by Akamai, for example. A status email 1501 or other notification may be transmitted to digital content management tool (DCMT) 1502 to identify the new game build/version. DCMT 1502 may publish the new game build/version to CDN 1530.

After publishing the build to CDN 1530, DCMT 1502 may update catalog 1504. Catalog 1504 may store/maintain various information about games provided by the game developer, as well as download uniform resource locators (URLs), and so on. After the game build is updated in catalog 1504, DCMT 1502 may be used to set a date (or date/time) when the new build will be “live,” e.g., available for download. The setting of such a build-live date triggers an event, e.g., a software changed event 1506.

Coordinator 1508, which may coordinate/control the use/operation of in-place updates in accordance with embodiments of the disclosed technology, and described herein, may listen to or otherwise monitor catalog 1504 for the existence of a software changed event 1506. Upon sensing or discovering software changed event 1506, coordinator 1508 may instruct one or more compute nodes 1512 to download the new (published) build, referred to as N, along with an M number of previous builds.

For example, as described herein, patch plans can be generated upon preparing a new build. As an illustrative example, version X may be due for an update to version N, version X-1 may be due for an update to Version N, version x-2 may be due for an update to version N, etc. In some embodiments, a “back” patch may be generated in the case there is a need to regress in build version, e.g., from version N back to version X (the current build). It should be noted that patch plans, and patch streams that are generated may be uploaded to CDN 1530 as additional data. In this way, when a client computing device-(e.g., a computing device that includes a software product version-such as video game) requests data to update a current build/version to a new/target build or version of software, a URL corresponding to an appropriate patch plan can be provided, together with any relevant patch streams.

In some examples, the patch plan is generated for in-place updates and no “back” patch is generated. When the update needs to be regressed in build version, a new software product or current build can be uploaded to CDN 1530. In this way, when a client computing device requests data to update a current build/version to a new/target build or version of software, a URL corresponding to a replacement software product can be provided as a patch stream.

In some examples, tunnel 1510 may support communications or connections between coordinator 1508 and DCMT 1502. Tunnel 1510 may comprise a REST application programming interface (API) connection to notify DCMT 1502 of changes in the status of a patch generation. This can be used to trigger, e.g., emails, to interested parties/entities regarding the state of deployment of a patch. In some embodiments, coordinator 1508 uses a MySQL server 1516 for tracking build states for patches that have been initiated by coordinator 1508. Build state data may be maintained in databases 1514A, 1514B, for example. Databases 1514A, 1514B can be hosted in a remote desktop services (RDS) host (not shown), such as a server (physical or virtual). Elastic file system (EFS) component 1518 can be used by compute nodes 1512 for serverless file storage/file sharing.

Orchestration component 1520 may control or effectuate timing, scheduling, scaling, deployment, or other management functions of coordinator 1508 and system 1500. Orchestration component 1520 may also manage other elements of the game developer system, i.e., the in-place update infrastructure. Orchestration can be effectuated using an orchestration system/method, such as Kubernetes using, in some embodiments, a yard master template.

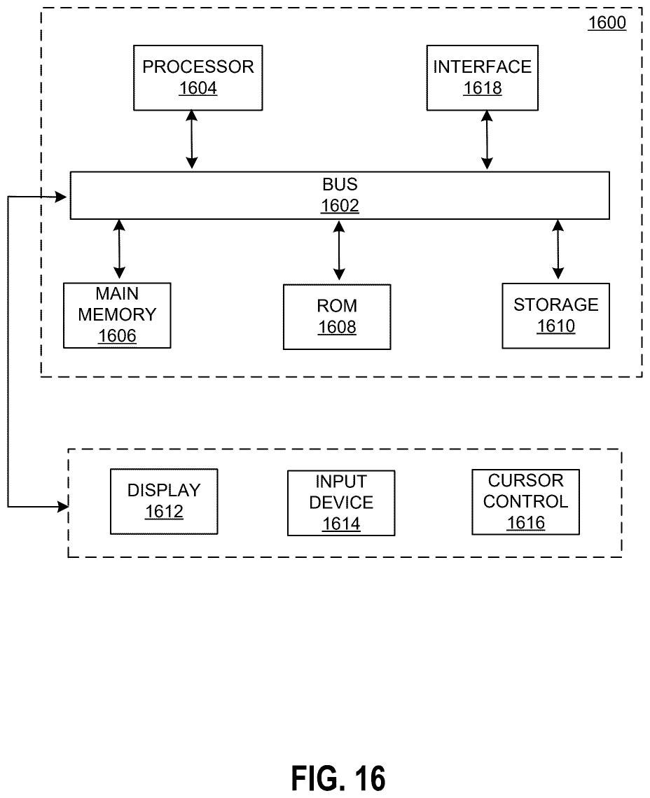

FIG. 16 depicts a block diagram of an example computer system 1600. Computing system 1600 is a computing device of which various embodiments described herein may be implemented. Computer system 1600 includes a bus 1602 or other communication mechanism for communicating information, one or more hardware processors 1604 coupled with bus 1602 for processing information. Hardware processor(s) 1604 may be, for example, one or more general purpose microprocessors.

Computer system 1600 also includes a main memory 1606, such as a random access memory (RAM), cache and/or other dynamic storage devices, coupled to bus 1602 for storing information and instructions to be executed by processor 1604. Main memory 1606 also may be used for storing temporary variables or other intermediate information during execution of instructions to be executed by processor 1604. Such instructions, when stored in computer readable memory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk, optical disk, or USB thumb drive (Flash drive), etc., is provided and coupled to bus 1602 for storing information and instructions.

Computer system 1600 may be coupled via bus 1602 to a display 1612, such as a liquid crystal display (LCD) (or touch screen), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. In some embodiments, the same direction information and command selections as cursor control may be implemented via receiving touches on a touch screen without a cursor.

Computing system 1600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable memory storage medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another computer readable memory storage medium, such as storage device 1610. Execution of the sequences of instructions contained in main memory 1606 causes processor(s) 1604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1610. Volatile media includes dynamic memory, such as main memory 1606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1602. Transmission media can also take the form of acoustic or light waves, such as those generated during radio-wave and infra-red data communications.

Computer system 1600 also includes interface 1618 coupled to bus 1602. Interface 1618 provides a two-way data communication coupling to one or more network links that are connected to one or more local networks. For example, interface 1618 may be an integrated services digital network (ISDN) card, cable modem, satellite modem, or a modem to provide a data communication connection to a corresponding type of telephone line. As another example, interface 1618 may be a local area network (LAN) card to provide a data communication connection to a compatible LAN (or WAN component to communicate with a WAN). Wireless links may also be implemented. In any such implementation, interface 1618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1618, which carry the digital data to and from computer system 1600, are example forms of transmission media.

Computer system 1600 can send messages and receive data, including program code, through the network(s), network link and interface 1618. In the Internet example, a server might transmit a requested code for an application program through the Internet, the ISP, the local network and interface 1618.

The received code may be executed by processor 1604 as it is received, and/or stored in storage device 1610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

By way of example and not limitation, a video game as used herein refers to a video game application comprising computer executable instructions that, when executed by a computing device, provide a virtual interactive environment for gameplay, such as by users or players of the video game. In some embodiments, one or more video game applications are accessible through a video game platform. As a non-limiting illustrative example, a video game platform is a software that enables users or players to manage or access video game applications and/or video game content, among other things.

As known to a person of ordinary skill in the art, a game engine uses data (e.g., state data, render data, simulation data, audio data, and other data types of the like) to generate and/or render one or more outputs (e.g., visual output, audio output, and haptic output) for one or more computing devices. In some embodiments, a game engine includes underlying frameworks and software for generating, simulating, or rendering one or more aspects of gameplay. As a non-limiting descriptive example, a game engine includes, among other things, a renderer, simulator, an audio engine, and a stream layer.

A renderer is a graphics framework that manages the rendering of graphics corresponding to lighting, shadows, textures, models, user interfaces, and other aspects of the like among a game engine. A simulator refers to a framework that manages simulation corresponding to physics and other corresponding mechanics-such as those used in part for driving or facilitating animations and/or interactions of gameplay objects, entities, characters, lighting, gasses, and other aspects of the like. A stream layer is a software layer that allows a renderer and simulator to execute independently of one another among a game engine by providing a common execution stream for renderings and simulations to be produced and/or synchronized (e.g., scheduled) at and/or during runtime. An audio engine or audio renderer provides audio playback among one or more audio channels. The output of an audio engine can also correspond to the common execution of a stream layer, for synchronization with rendering and simulation during runtime.

In some embodiments, the data of a video game includes state data, simulation data, rendering data, audio data, animation data, and other data of the like used and/or produced by or among a game engine during runtime execution.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to the simulation (e.g., physics and other corresponding mechanics) of a character or object in a game engine. For example, simulation data can include the joint and structural configuration of a character model and corresponding physical forces or characteristics applied to it at an instance or period of time during gameplay, such as a “frame”, to create animations, among other things.

Render Data is commonly known as the underlying data corresponding to rendering aspects (e.g., visual and auditory rendering) of a game session, which are rendered (e.g., for output to an output device) by a game engine. For example, render data can include data corresponding to the rendering of graphical, visual, auditory, and/or haptic output of a video game, among other things.

Digital game assets (or game assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, interactions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types of game data for processing and/or storage.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system comprising:
a processor; and
a computer readable memory storage medium communicatively coupled to the processor, the computer readable memory storage medium storing instructions that, when executed by the processor, cause the processor to:
create, among a content delivery network, a patch plan for updating a plurality of software builds of a video game to each subsequent software build of the video game among the plurality, wherein for each patch plan created the system is configured to:
identify reusable resources of a source software build for a target software build,
concatenate adjacent blocks representative of the identified reusable resources for use in the target software build,
identify additional resources for the target software build based on edges of the identified reusable resources,
identify downloadable resources for the target software build, and
create the patch plan in accordance with the identified reusable resources and the downloadable resources,
receive a request to update the video game from the source software build to the target software build,
identify, in response to the request, the patch plan corresponding to the update of the video game from the source software build to the target software build,
send the corresponding patch plan.

2. The system of claim 1, wherein the sent patch plan is configured for execution on a computing device to update the source software build of the video game stored on the computing device, wherein the patch plan is configured to cause the computing device to:
organize first reusable data and second reusable data in the patch plan, the patch plan defining data movement and storage operations to update the source software build to the target software build;
determine a data movement operation in the patch plan that moves the first reusable data from a source location to an overlapping storage location of the second reusable data;
in response to determining that the second reusable data is to be reused in the target software build, update the data movement operation in the patch plan to:
store the second reusable data in a memory buffer prior to initiating the data movement operation to the overlapping storage location,
store the first reusable data from the source location to the overlapping storage location, and
store the second reusable data from the memory buffer to a target location in target software build; and
execute the patch plan with the updated data movement operation.

3. The system of claim 2, wherein the memory buffer, the source software build, and the target software build are located at the computing device.

4. The system of claim 2, wherein the memory buffer is a first memory buffer, and wherein the patch plan is further configured to cause the computing device to:
determine a second data movement operation in the patch plan that moves third reusable data from a second target location to a second overlapping storage location of fourth reusable data, and
update the second data movement operation in the patch plan to:
store the fourth reusable data in a second memory buffer prior to initiating the second data movement operation to the second overlapping storage location,
store the third reusable data from the second target location to the second overlapping storage location, and
store the fourth reusable data from the second memory buffer to the second target location.

5. The system of claim 1, wherein identifying the reusable resources of the source software build for the target software build further causes the processor to:
generate target build artifacts comprising target build file metadata and instructions to scan the target software build in accordance with a determined block size,
calculate a scan hash and cryptographic hash for blocks of the target software build,
perform a scan of the source software build in accordance with the determined block size, and
identify blocks of the source software build with the scan hash that matches the blocks of the target software build.

6. The system of claim 1, wherein the instructions that cause the processor to identify the reusable resources comprise further instructions that when executed, cause the processor to generate target software build artifacts.

7. The system of claim 6, wherein the target software build artifacts comprise target software build file metadata and instructions to scan the target software build in accordance with a determined block size.

8. The system of claim 1, wherein the instructions that cause the processor to identify the reusable resources comprise further instructions that when executed, cause the processor to perform a scan of the source software build in accordance with a determined block size.

9. The system of claim 8, wherein the instructions that cause the processor to identify the reusable resources comprise further instructions that when executed, cause the processor to identify those blocks of the source software build with that of blocks of the target software build.

10. A version patching server comprising:
a processor; and
a computer readable memory storage medium communicatively coupled to the processor, the computer readable memory storage medium storing instructions that, when executed by the processor, cause the processor to:
monitor a game development system for a software changed event associated with a target software build for upgrading a source software build; and
in response to discovering a software changed event, instructing a computing device to download the target software build and a corresponding patch plan providing instructions regarding how the computing device is to execute an in-place update the source software build to the target software build on the computing device.

11. The version patching server of claim 10, wherein the patch plan is configured to cause the computing device to:
organize first reusable data and second reusable data in the patch plan, the patch plan defining data movement and storage operations to update the source software build to the target software build;
determine a data movement operation in the patch plan that moves the first reusable data to an overlapping storage location of the second reusable data;
in response to determining that the second reusable data is to be reused in the target software build, update the data movement operation in the patch plan to:
store the second reusable data in a memory buffer prior to initiating the data movement operation to the overlapping storage location,
store the first reusable data from a source location in the overlapping storage location, and
store the second reusable data from the memory buffer in a target location of the target software build; and
execute the patch plan with the updated data movement operation.

12. The version patching server of claim 11, wherein the sent patch plan is configured for execution on a computing device to update the source software build of a video game stored on the computing device.

13. The version patching server of claim 11, wherein the memory buffer, the source software build, and the target software build are located at the computing device.

14. The version patching server of claim 11, wherein the memory buffer is a first memory buffer, and wherein the patch plan is further configured to cause the computing device to:
determine a second data movement operation in the patch plan that moves third reusable data from a second target location to a second overlapping storage location of fourth reusable data, and
update the second data movement operation in the patch plan to:
store the fourth reusable data in a second memory buffer prior to initiating the second data movement operation to the second overlapping storage location,
store the third reusable data from the second target location to the second overlapping storage location, and
store the fourth reusable data from the second memory buffer to the second target location.

15. The version patching server of claim 11, wherein identifying the first reusable data of the source software build for the target software build further causes the processor to:
generate target build artifacts comprising target build file metadata and instructions to scan the target software build in accordance with a determined block size,
calculate a scan hash and cryptographic hash for blocks of the target software build,
perform a scan of the source software build in accordance with the determined block size, and
identify blocks of the source software build with the scan hash that matches the blocks of the target software build.

16. The version patching server of claim 11, wherein the instructions that cause the processor to identify the first reusable data comprise further instructions that when executed, cause the processor to generate target software build artifacts.

17. The version patching server of claim 16, wherein the target software build artifacts comprise target software build file metadata and instructions to scan the target software build in accordance with a determined block size.
